(19) United States
(12) Patent Application Publication
(10) Pub. No.: US 2016/0185417 A1
(43) Pub. Date: Jun. 30, 2016

(54) FREEWHEELING UNICYCLE

(71) Applicant: Gordon C. Tang, Bellevue, WA (US)

(72) Inventor: Gordon C. Tang, Bellevue, WA (US)

(21) Appl. No.: 14/824,332

(22) Filed: Aug. 12, 2015

Related U.S. Application Data
(60) Provisional application No. 62/036,557, filed on Aug. 12, 2014.

(51) Int. Cl. B62M 1/32; F16D 41/12; B62K 3/00

(52) U.S. Cl. CPC B62M 1/32; B62K 3/002; F16D 41/12

(57) ABSTRACT

The current document is directed to a two-wheeled unicycle that features bicycle-like pedals and a freewheeling mechanism to allow a rider to coast while the unicycle moves forward. In one implementation, he pedals are affixed to a horizontal drive shaft that rotates with respect to the wheels of the two-wheeled unicycle via two ball bearings. The horizontal drive shaft transfers rotational force through a ratchet-based, freewheeling mechanism to a larger-diameter cylindrical shaft to which the two wheels are affixed. The freewheeling mechanism transfers forward pedaling motion to the wheels. However, the wheels can rotate freely in a forward direction even when the pedals are maintained in a fixed orientation with respect to the surface on which the unicycle is traveling or another fixed reference point.

### CROSS-REFERENCE TO RELATED APPLICATION

This application claims the benefit of Provisional Application No. 62/036,557, filed Aug. 12, 2014.

### TECHNICAL FIELD

The current document is related to pedal-powered devices and, in particular, to a two-wheeled unicycle that features a freewheeling mechanism to allow a unicycle rider to coast or, in other words, to move forward, with wheel rotation, after having discontinued pedaling.

### BACKGROUND

Two-wheeled unicycles were developed in the 1980s and found significant commercial success as recreational toys, ski-training devices, and exercise devices. However, these two-wheeled unicycles featured fixed pedals that required a user to continue to pedal in order to move forward or backward on the two-wheeled unicycle. Unicycles commonly have fixed pedals that provide stability and balance control to riders.

### SUMMARY

The current document is directed to a two-wheeled unicycle that features bicycle-like pedals and a freewheeling mechanism to allow a rider to coast while the unicycle moves forward. In one implementation, he pedals are affixed to a horizontal drive shaft that rotates with respect to the wheels of the two-wheeled unicycle via two ball bearings. The horizontal drive shaft transfers rotational force through a ratchet-based, freewheeling mechanism to a larger-diameter cylindrical shaft to which the two wheels are affixed. The freewheeling mechanism transfers forward pedaling motion to the wheels. However, the wheels can rotate freely in a forward direction even when the pedals are maintained in a fixed orientation with respect to the surface on which the unicycle is traveling or another fixed reference point.

### BRIEF DESCRIPTION OF THE DRAWINGS

FIG. 1 shows the freewheeling two-wheeled unicycle to which the current document is directed.

FIG. 2 provides a diagram of one implementation of the freewheeling mechanism.

FIG. 3 shows a typical ball bearing.

### DETAILED DESCRIPTION

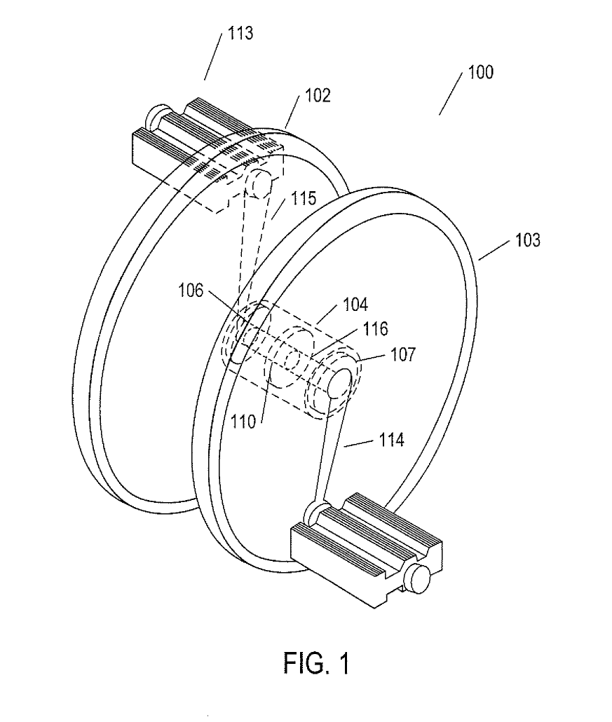

FIG. 1 shows the freewheeling two-wheeled unicycle to which the current document is directed. The freewheeling two-wheeled unicycle 100 includes two wheels 102-103 that are interconnected by a large-diameter hollow cylindrical shaft 104. Mounted within the hollow cylindrical shaft are two ball bearings 106-107 and a circular, ratchet-based freewheeling mechanism 110. The two ball bearings and circular, ratchet-based freewheeling mechanism are mounted by one or more of a friction fit, an adhesive, and mechanical fasteners. Two pedals 112-113 are rotatably mounted to crank arms 114-115, respectively, which are, in turn, non-rotatably coupled to a horizontal drive shaft 116. The drive shaft rotates with respect to the two wheels and large-diameter hollow cylindrical shaft 104 via ball bearings 106 and 107. Force applied to the pedals to rotate the pedals in a forward direction, as indicated by arrow 120, is transferred through the freewheeling mechanism 110 to the large-diameter hollow cylindrical shaft 104 and wheels 102 and 103. However, the wheels may freely rotate in the forward direction even when a rider holds the pedals in a fixed orientation with respect to an external reference point. In other words, the two-wheeled unicycle can be ridden much like a bicycle with a freewheeling mechanism. On a hill, for example, the rider may coast and continue to travel in a forward direction without pedaling. Similarly, a rider may pedal vigorously to achieve a desired velocity and then coast, without pedaling, for a significant distance. The pedals and cylindrical drive shaft freely rotate in a backward direction with respect to the hollow cylindrical shaft.

The wheels 102 and 103 may be solid disk-shaped wheels made from wood, fiberglass, metal, plastic, or other rigid or semi-rigid materials. Alternatively, the wheels may have solid rims and spokes, similar to bicycle wheels. In yet additional alternative implementations, the wheels may be rigid, one-piece manufactures with significant cutouts to form two or more spoke-like structural members.

The two-wheeled unicycle provides significant mechanical stability to a rider, allowing the rider to shift weight between pedals by a significant amount without causing the unicycle to tilt to one side or the other and without causing the unicycle rider to lose balance and fall. As a result, the rider can maintain balance and directional control even when coasting.

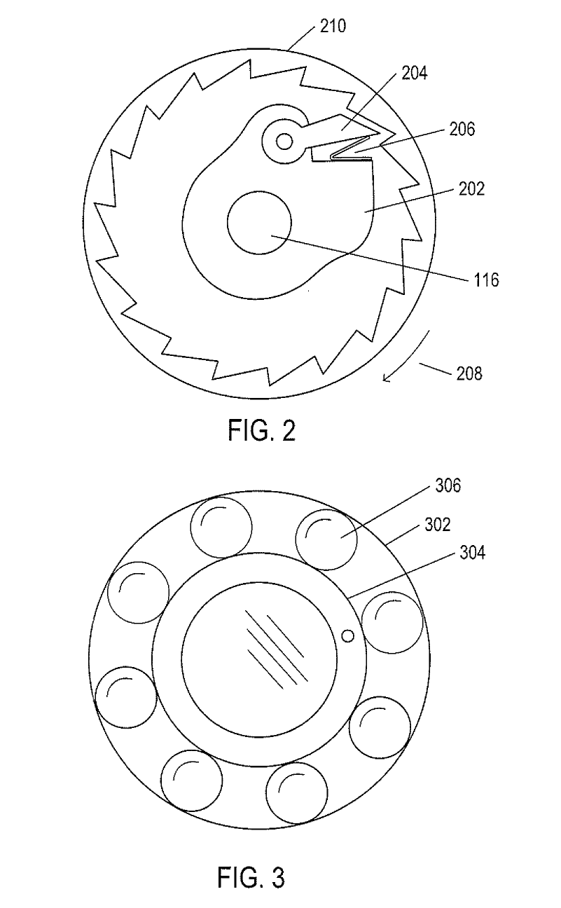

FIG. 2 provides a diagram of one implementation of the freewheeling mechanism 110. The drive shaft 116 is viewed on end in FIG. 2. The drive shaft is connected to an internal component 202 on which an angular pall 204 is rotatably mounted. The pall is additionally connected to the mounting component 202 through a hinge-like spring 206. When the drive shaft rotates in a forward direction, as indicated by arrow 208, with respect to an outer ratchet wheel 210, the pall engages with the outer ratchet wheel to transfer torque to the outer ratchet wheel. However, the outer ratchet wheel may rotate freely in the forward direction with respect to the pall and drive shaft.

FIG. 3 shows a typical ball bearing. Ball bearings 106 and 107 provide a freely rotating mount of the drive shaft 116 to the two-wheeled unicycle body comprising the large-diameter hollow cylindrical shaft 104 and the two wheels 102 and 103. The ball bearing includes an outer race 302 attached to the large-diameter hollow cylindrical shaft and an inner race 304 attached to the drive shaft. The drive shaft rotates freely with respect to the outer race via rotation of spherical metal balls, such as metal ball 306, confined within a channel formed by the inner and outer races.

Although the present invention has been described in terms of particular embodiments, it is not intended that the invention be limited to these embodiments. Modifications within the spirit of the invention will be apparent to those skilled in the art. For example, any of many different types of materials may be used for constructing the wheels, large-diameter hollow cylindrical shaft connected to the two wheels, pedals, crank arms, and drive shaft. Various different types of freewheeling mechanisms can be used for transfer of torque for the pedals to the wheels. Various types of rotatable mounts, in addition to the classic ball-bearing implementation discussed above, may be used for rotatably mounting the drive shaft to the two-wheeled unicycle. Pedals can be made of many different types of materials, including plastic, hard rubber, metal, and wood. In certain embodiments, a friction inducing mechanism can be incorporated in the freewheeling mechanism so that, when the pedals are rotated in a backward direction, rotation of the hollow cylindrical shaft with respect to the cylindrical drive shaft is inhibited to slow forward motion of the two-wheeled unicycle.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A two-wheeled, freewheeling unicycle comprising:
two interconnected wheels;
a freewheeling torque-transfer assembly that transfers torque applied to the torque-transfer mechanism to rotate the two interconnected wheels in a forward direction; and
two pedals coupled to the freewheeling torque-transfer assembly through which torque is applied to the torque-transfer mechanism.

2. The two-wheeled, freewheeling unicycle of claim 1 wherein the two interconnected wheels further comprise:
a hollow, cylindrical shaft; and
the two wheels, a first wheel of the two wheels non-rotatably mounted to a first end of the hollow, cylindrical shaft and a second wheel of the two wheels non-rotatably mounted to a second end of the hollow, cylindrical shaft.

3. The two-wheeled, freewheeling unicycle of claim 2 wherein the freewheeling torque-transfer assembly comprises:
a cylindrical drive shaft;
a cylindrical ratchet-based freewheeling mechanism, a first component of which is mounted to the cylindrical drive shaft and a second component of which is mounted to the inner surface of the hollow, cylindrical shaft; and
two ball bearings that rotatably mount the cylindrical drive shaft within the hollow, cylindrical shaft, a first ball bearing of the two ball bearings mounted within the hollow, cylindrical shaft proximal to the first end of the hollow, cylindrical shaft and a second ball bearing of the two ball bearings mounted within the hollow, cylindrical shaft proximal to the second end of the hollow, cylindrical shaft.

4. The two-wheeled, freewheeling unicycle of claim 3 wherein the cylindrical ratchet-based freewheeling mechanism further comprises:
the first component to which an angular pall is rotatably mounted and additionally connected to the first component by a hinge-like spring; and
the second component having a cylindrical outer surface and a toothed inner surface.

5. The two-wheeled, freewheeling unicycle of claim 4 wherein an end of the angular pall opposite from a second end rotatably mounted to the first component is shaped to engage an asymmetrical, ratchet tooth of the second component in order to transfer torque from the cylindrical drive shaft to the hollow, cylindrical shaft when torque is applied to the cylindrical drive shaft in a forward direction and to slide without engagement to the asymmetrical, ratchet teeth of the second component when torque is applied to the cylindrical drive shaft in a backward direction.

6. The two-wheeled, freewheeling unicycle of claim 3 wherein a first pedal of the two pedals is rotatably mounted to a first end of a first crankshaft, the second end of which is non-rotatably mounted to a first end of the cylindrical drive shaft and wherein a second pedal of the two pedals is rotatably mounted to a first end of a second crankshaft, the second end of which is non-rotatably mounted to a second end of the cylindrical drive shaft.

7. The two-wheeled, freewheeling unicycle of claim 3 wherein the cylindrical ball bearings and cylindrical ratchet-based freewheeling mechanism are mounted to the inner surface of the hollow, cylindrical shaft by one or more of:
a friction fit;
an adhesive; and
mechanical fasteners.

8. The two-wheeled, freewheeling unicycle of claim 3 wherein each of the two wheels is one of:
a solid disk-shaped wheel made from wood, fiberglass, metal, plastic, or other rigid or semi-rigid materials;
a wheel with solid rims and spokes; and
a rigid, one-piece manufacture with cutouts to form two or more spoke-like structural members.

9. The two-wheeled, freewheeling unicycle of claim 1 wherein a rider stands on the two pedal and moves the two-wheeled, freewheeling unicycle forward by differentially applying pressure to the two pedals to rotate the pedals with respect to an axis corresponding to the cylindrical drive shaft in a forward direction and wherein, once moving forward on the two-wheeled, freewheeling unicycle, discontinues differentially applying pressure to the two pedals and stands on the pedals while continuing to coast forward.

10. The two-wheeled, freewheeling unicycle of claim 1 a friction-inducing mechanism is incorporated in the freewheeling mechanism so that, when the pedals are rotated in a backward direction, rotation of the hollow cylindrical shaft with respect to the cylindrical drive shaft is inhibited to slow forward motion of the two-wheeled unicycle.

11. A two-wheeled, freewheeling unicycle comprising:
two wheels interconnected by a hollow, cylindrical shaft;
a drive shaft rotatably mounted within the hollow, cylindrical shaft by two cylindrical ball bearings;
a freewheeling mechanism that transfers torque from the drive shaft to the large-diameter hollow cylindrical shaft; and
two pedals rotatably mounted to two crankshaft arms that are, in turn, fixedly mounted to the drive shaft.

12. The two-wheeled, freewheeling unicycle of claim 11 wherein a first wheel of the two wheels is non-rotatably mounted to a first end of the hollow, cylindrical shaft and a second wheel of the two wheels is non-rotatably mounted to a second end of the hollow, cylindrical shaft.

13. The two-wheeled, freewheeling unicycle of claim 11 wherein the freewheeling mechanism is a cylindrical ratchet-based freewheeling mechanism comprising:
a first component mounted to the cylindrical drive shaft; and
a second component mounted to the inner surface of the hollow, cylindrical shaft.

14. The two-wheeled, freewheeling unicycle of claim 13 wherein the cylindrical ratchet-based freewheeling mechanism further comprises:
the first component to which an angular pall is rotatably mounted and additionally connected to the first component by a hinge-like spring; and
the second component having a cylindrical outer surface and a toothed inner surface.

15. The two-wheeled, freewheeling unicycle of claim 14 wherein an end of the angular pall opposite from a second end rotatably mounted to the first component is shaped to engage an asymmetrical, ratchet tooth of the second component in order to transfer torque from the cylindrical drive shaft to the hollow, cylindrical shaft when torque is applied to the cylindrical drive shaft in a forward direction and to slide without engagement to the asymmetrical, ratchet teeth of the second component when torque is applied to the cylindrical drive shaft in a backward direction.

16. The two-wheeled, freewheeling unicycle of claim 13 wherein the cylindrical ball bearings and cylindrical ratchet-based freewheeling mechanism are mounted to the inner surface of the hollow, cylindrical shaft by one or more of:
a friction fit;
an adhesive; and
mechanical fasteners.

17. The two-wheeled, freewheeling unicycle of claim 11 wherein each of the two wheels is one of:
a solid disk-shaped wheel made from wood, fiberglass, metal, plastic, or other rigid or semi-rigid materials;
a wheel with solid rims and spokes; and
a rigid, one-piece manufacture with cutouts to form two or more spoke-like structural members.

18. The two-wheeled, freewheeling unicycle of claim 11 wherein a friction-inducing mechanism is incorporated in the freewheeling mechanism so that, when the pedals are rotated in a backward direction, rotation of the hollow cylindrical shaft with respect to the cylindrical drive shaft is inhibited to slow forward motion of the two-wheeled unicycle.
